(19) United States
(12) Patent Application Publication
(10) Pub. No.: US 2009/0327437 A1
(43) Pub. Date: Dec. 31, 2009

(54) REAL TIME MEDIA-BASED SOCIAL NETWORK NOTIFICATIONS

(75) Inventor: Julio Estrada, Medina, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/165,649

(22) Filed: Jun. 30, 2008

(51) Int. Cl. G06F 15/16

(52) U.S. Cl. 709/206

(57) ABSTRACT

Real time media-based social network notifications are utilized to provide updates of events that occur in a social network in real time. By providing a data feed of events which are monitored in the social network to a real time media system such as a presence-based messaging network, users can be kept up to date with events as they occur in the social network with alerts or instant messages.

### BACKGROUND

Web-based social networking has become a popular way for people to meet and interact with people over public networks like the Internet. Typically, social networking is implemented by websites that provide a social networking service. Social networking services are often stand alone or dedicated web-based services although some services are integrated as part of other service offerings. Social networking services allow members to view other member profiles, join groups with a common subject or theme, add other members to a contact list, and send messages to other members. Some social networking services are reputation-based where members can receive reviews and ratings from other users and/or receive recognition for possessing certain attributes or performing certain actions.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Real time media-based social network notifications are utilized to provide updates of events that occur in a social network in real time. By providing a data feed of events which are monitored in the social network to a real time media system such as a presence-based messaging network, users can be kept up to date with events as they occur in the social network with alerts or instant messages.

In various illustrative examples, events in the social network can include activities of the user's friends (or other members of user's social graph) that may be of interest to the user. Notifications can be automatically triggered and sent to the user of the presence-based network upon the occurrence of different events such as when a friend listens to a particular song, updates her profile, indicates a favorite song or artist, receives an award, and the like. The notification will then be sent to the presence-based network so that it appears as a message to inform user about the recent activity pertaining to the friend. In some implementations, the user may select particular categories of events for which notification messages should be received and may also select the members of the social network and/or presence-based network to which the notifications should pertain.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 show an illustrative networking environment in which the present real time media-based notifications may be utilized;

FIG. 2 shows a portable media player when docked in a docking station that is operatively coupled to a personal computer (“PC”) and where the PC is connected to a media content delivery and a social networking service over a network such as the Internet;

FIG. 3 shows an illustrative arrangement in which events are monitored in a social network and provided to a presence-based network as notifications;

FIG. 4 shows an illustrative set of events that may be monitored and fed to the presence-based network; and

FIG. 5 is a screen shot of an illustrative instant messaging interface in which notifications from the social network may be shown to a user as a message.

Like reference numerals indicate like elements in the drawings.

### DETAILED DESCRIPTION

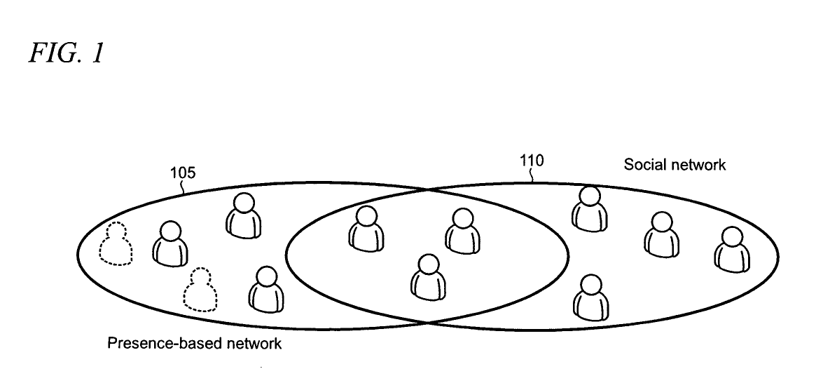

FIG. 1 shows an illustrative networking environment 100 in which the present real time media-based notifications may be utilized. Environment 100 includes two networks including a social network 105 and a presence-based network 112 that are each provided as respective on-line services.

In this example, the presence-based network 112 is arranged as an instant messaging (“IM”) network that supports multiple contacts (collectively indicated by reference numeral 116) that typically represent other people with whom the users of the IM network may interact in real-time conversations at their PCs over an Internet connection. Presence-based networks are arranged to communicate the availability of contacts (i.e. their status as being online or off-line) to users. Offline contacts are shown with dashed outlines in FIG. 1.

The social network 105 enables an on-line community of members (collectively identified by reference numeral 123) to explore, discover, and share media content experiences, typically including music and video. For example, a member may recommend a song to a friend, share a playlist of favorite songs, post messages/reviews/ratings in chat room and forums, and conduct discussions, and the like. To use a social networking service, a member may provide information to set up an account with a social networking service. Once a member's account is configured, users can generate “profiles” of themselves. The profiles typically contain a variety of information about a user (such as location, occupation, hobbies, likes/dislikes, friends/social graph, etc.). Members will often interact with one other based on information contained in their profiles.

As shown in FIG. 1, there can be overlap between members of the social network 110 and users of the presence-based network 105. In some implementations, notifications may be generated only about events that are associated with a user who belongs to both groups and sent to a user who also belongs to both groups. In other implementations, such common membership is not required (either for the notification recipient or for the user to which the notification pertains).

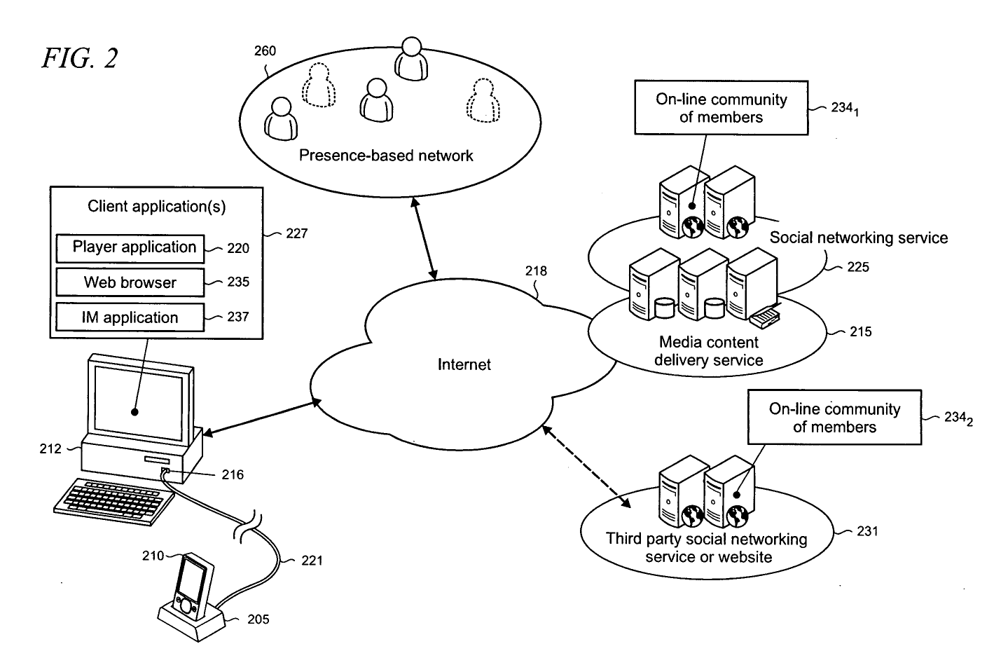

FIG. 2 shows a personal media player 210 as typically inserted into a dock 205 for synchronization with a PC 212. Dock 205 is coupled to an input port 216 such as a USB (Universal Serial Bus) port with a synchronization (“sync”) cable 221, in this example. Other arrangements may also be used to implement communications between the personal media player 210 and PC 212 including, for example, those employing wireless protocols such as Bluetooth, or Wi-Fi (i.e., the Institute of Electrical and Electronics Engineers, IEEE 802.11 standards family) that enable connection to a wireless network or access point. The wireless communications capability in the player 210 can also be utilized to implement peer-to-peer connectivity with other players that are similarly equipped.

The personal media player 210 is arranged to be operatively couplable with the PC 212 using a synchronization process by which data may be exchanged or shared between the devices. The synchronization process implemented between the PC 212 and personal media player 210 typically enables media content such as music, video, images, games, information, and other data to be downloaded from an online source or media content delivery service 215 over a network such as the Internet 218 to the PC 212. In this way, the PC 212 operates as an intermediary or proxy device between the service 215 and the personal media player 210.

The media content provided by the service 215 will typically be organized and presented to a user using a player application 220 that runs on the PC 212 as one of several client applications 227. The player application 220 is arranged to enable the user to browse, select, and download media content from the service 215, often on a fee basis or as part of a subscription plan. In some cases, advertising supported business models may also be utilized. The downloaded media content can be consumed on the PC 212 or be transferred to the personal media player 210. Media content may be protected in some instances where its limitations on its use may be enforced by various DRM (digital rights management) systems that interoperate between the 2C 312 and the player 210.

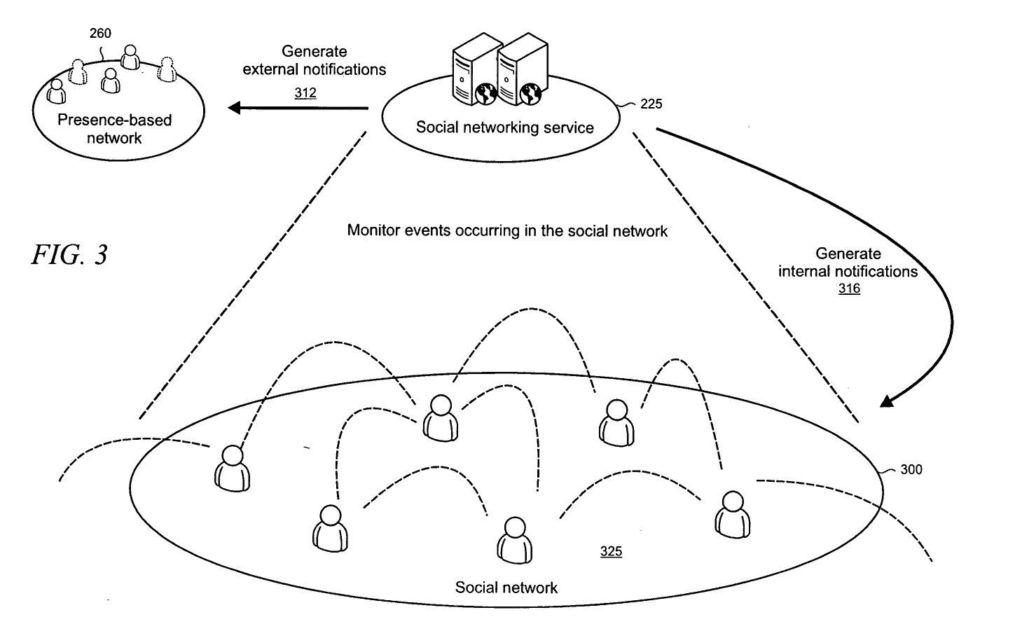

In this example, a social networking service 225 supplements the media content delivery service 215. The social networking service 225 can be supported by a common service provider, as shown, but a service 231 may alternatively be provided by a third party (as indicated by the dashed line in FIG. 3). In each case, the social networking service will typically support an on-line community of members, as indicated by reference numerals 334₁ and 334₂. The user will typically use a web browser 235 running on the PC 312 to interact with the social networking service 225.

A presence-based network 250 is also shown in FIG. 2 and coupled to the Internet 218. The user will typically interact with the presence-based network 250 using an IM interface 237 that runs on the PC 212.

FIG. 3 shows an illustrative arrangement in which events are monitored in a social network 300 supported by the service 215. Responsively to the monitored events, the service 215 generates notifications which are provided to the presence-based network 260 as external notifications 312. Internal notifications 316 will also typically be supported that can be sent to member of the social network 300 using a messaging system that is internal to the network.

Any of a variety of events and activities occurring in the network 300 may be monitored by the service 215 including interactions between social network members (collectively identified by reference numeral 325) and those between the members and the service 215 or external resources or entities as indicated by the dashed lines in FIG. 3. In most implementations, a user who receives the notifications of the events can pick the social network members 325 whose activities will be monitored. Typically these will include friends of the user, or other members of the user's social graph (i.e., the network of connections and relationships among people using the service 215 such as friends of the users, and friends of friends, etc). In some implementations, the user will also be enabled by the service 215 to select which subset of all possible activities and events that occur in the social network 300 are monitored for purposes of generating notifications.

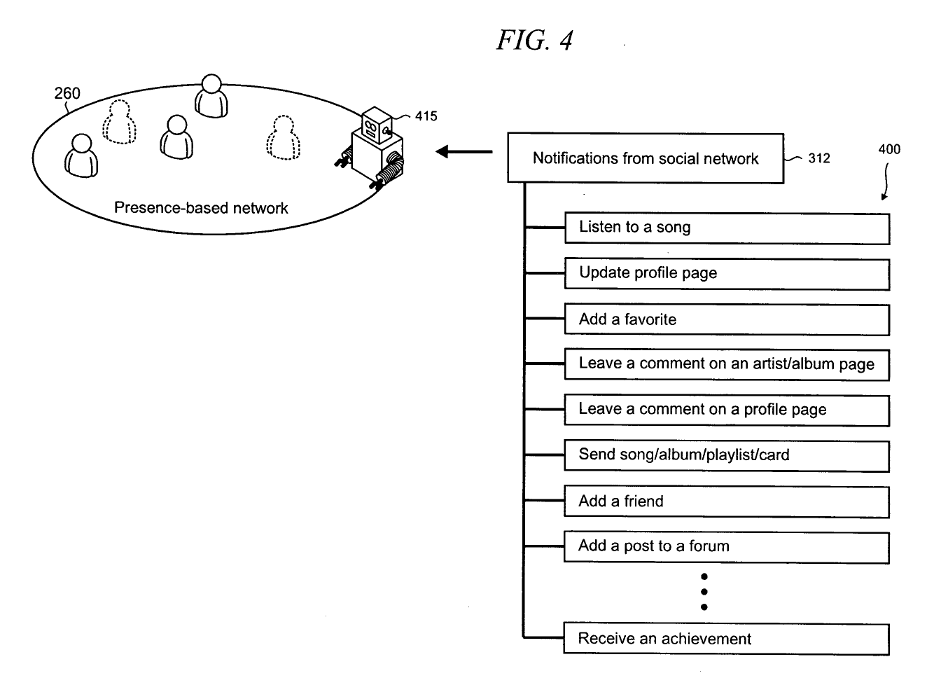

FIG. 4 shows an illustrative set of events 400 that may be monitored and fed in the form of notifications 312 to the presence-based network 260. It is emphasized that the set 400 is intended to be illustrative and that other events may also be monitored as may be required to meet the needs of a particular implementation. In one example scenario, the user receiving the notification from the presence-based network 260 may be assumed to be a member of the social network 300 who has selected a friend in the network whose activities will be monitored by the service 215. The events include the friend performing the following:
Listening to a song
Updating his or her profile page
Adding a piece of media content like a song or video to a favorites list
Leaving a comment on an artist/album page
Leaving a comment on another member's profile page
Sending a song/album/playlist/profile to another member
Adding a friend to his or her page
Adding a post to a forum or chat room
Receiving an achievement or other recognition from the service (e.g., for being a “power listener”

Typically, the notifications will be implemented using a conventional IM messaging interface that is typically used for users to communicate in real time with one or more live contacts in the presence-based network 260. In one illustrative example, a “bot” 415 (i.e., robot) or other automated presence is used to personify the notification process by acting as the notification delivery agent on the presence-based network 260. So, for example, the bot can carry on natural language interaction with the user when delivering the notification by providing additional details, if asked by the recipient, about the event.

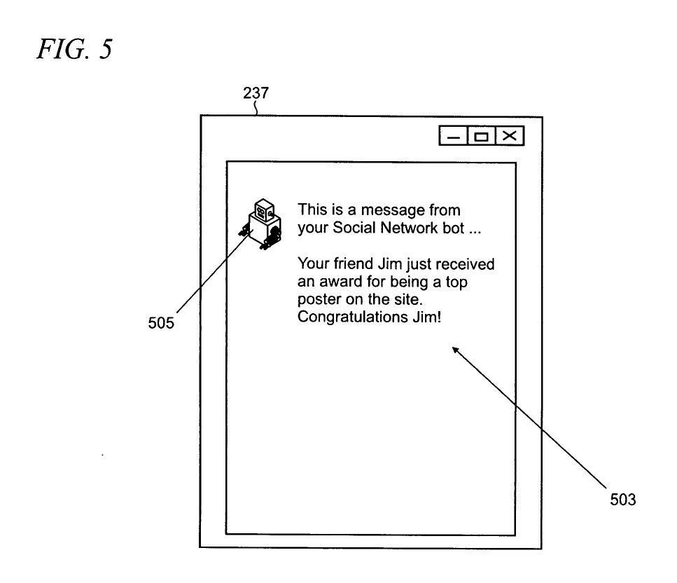

An exemplary IM messaging interface 237 is shown in FIG. 5. Here, the bot is named the “Social Network Bot” and has delivered a notification 503 that a friend of the user named Jim just received an award from the service 215 for being a top poster to a forum. A graphic 505 of the bot is shown to the user on the IM messaging interface 237 to indicate to the user that he is interacting with a bot and not a real person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing a notification in real time to a user of a presence-based network, the method comprising the steps of:
monitoring events that occur in a social network;
responsively to the monitoring, generating a notification about an event; and
sending the notification for delivery to the user through the presence-based network.

2. The method of claim 1 in which the presence-based network is an IM network.

3. The method of claim 2 in which notification is delivered through an IM messaging interface.
